(19) United States
(12) Patent Application Publication
(10) Pub. No.: US 2005/0057369 A1
(43) Pub. Date: Mar. 17, 2005

(54) Remote controller having auto-search and timer-controlled emitting functions

(76) Inventor: Jung-Hua Lai, Yungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/662,310

(22) Filed: Sep. 16, 2003

(51) Int. Cl. G08C 19/12; G08C 19/00

(52) U.S. Cl. 340/825.69; 341/176

(57) ABSTRACT

A remote controller includes a CPU having a main memory for recording the search addresses and codes of multiple product models and a second memory for recording the address flags of the product models indicated by the 26 English characters, a procedure table memory for recording the functions of keys of the product models and to provide the data of the function of every key for locking, a timer for counting the search until an interruption appears for locking and emitting power signal, a time interval control for controlling time interval for locking during searching, a search interruption control for locking control, and a signal emitter for emitting a frequency modulated search signal.

### BACKGROUND OF THE INVENTION

1. Field of the Invention

The present invention relates to a remote controller and, more particularly, to such a remote controller, which has the functions of auto-search and timer-controlled emitting function

2. Description of the Related Art

Regular commercially available electric home appliances are commonly equipped with a remote controller for operation control at a remote place. When the remote controller of an electric home appliance was lost, it may be inconvenient to purchase a substitute from the original electric home appliance supplier. Various remote controllers that fit electric home appliances of different models from different suppliers have been disclosed, and have appeared on the market. U.S. Pat. NO. 5,910,784 discloses a control circuit of a remote controller, which comprises a CPU, the CPU having a data memory adapted to store signal codes of different electric apparatuses, a procedure table memory adapted to record key switch functions of different electric apparatuses, a computing element for sequencing through a plurality of the stored signal codes, a search interruption adapted to interrupt the sequential output of the signal codes when an output code is in conformity with a selected function of a particular electric apparatus, and an emission output device coupled to the CPU to transmit the signal codes to the electric apparatus. Because there are a number of electric home appliances providing a number of electric home appliances of different models, it takes much time to achieve searching when a remote controller which is not provided by the original electric home appliance supplier is used. For example, if there are 1000 product models respectively coded by the codes ranging from 000˜999, and the auto searching frequency and emission time is assumed to be 1.4+0.4=1.8 seconds, thus it requires 2 minutes and 40 seconds to complete the whole searching cycle. Therefore, it is desirable to provide a remote controller which has the functions of auto-search and timer-controlled emitting function.

### SUMMARY OF THE INVENTION

The present invention has been accomplished under the circumstances in view. According to one aspect of the present invention, the remote controller comprises a CPU, the CPU comprising a main memory (random access memory) adapted to record the search addresses and codes of a plurality of product models, and at least one second memory adapted to record the address flags of all product models indicated by the 26 English characters A˜Z to establish a product model code table corresponding to the numerical keys 0˜12 and keys CH+, CH−, VOL+, VOL−at the remote control, for example, the initial A of AIWA is placed at the address 1 and the initial H of HITACHI is placed at the address 8; a procedure table memory (read only memory) adapted to record the functions of keys of the product models and to provide the data of the function of every key for locking; a timer adapted to count the search until an interruption appears for locking and to emit power signal from pre-set counting start time to pre-set counting end time; a time interval control adapted to control time interval for locking during searching; a search interruption control adapted to interrupt the searching action and to lock the frequency when the frequency matched, and a signal emitter adapted to transmit a frequency modulated search signal.

According to another aspect of the present invention, the remote controller further comprises a LCD coupled to the CPU for displaying the setting date and time and the process of auto searching, so that the user can know the current operation mode and the code, and the current time and product code when locking.

According to still another aspect of the present invention, the remote controller can be set to automatically emit power signal to turn on/off the electric home appliance at the set time. Therefore, when nobody is at home, the remote controller automatically emits power signal to turn on/off the electric home appliance at the set time, assuming the presence of a person at home.

### BRIEF DESCRIPTION OF THE DRAWINGS

FIG. 1 is a diagram of a control circuit used in a remote controller according to the present invention.

FIG. 2 is a key matrix function conversion table according to the present invention.

FIG. 3 is a circuit block diagram of the present invention.

FIG. 4 is an operation flow chart of the remote controller according to the present invention.

FIG. 5 is a block diagram of an alternate form of the present invention.

FIG. 5-1 is a block diagram of another alternate form of the present invention.

FIG. 5-2 is a block diagram of still another alternate form of the present invention.

FIG. 6 is a LCD setting flow chart according to the present invention.

FIG. 7A is a schematic drawing showing an example of one single key auto search operation according to the present invention.

FIG. 7B is a schematic drawing showing an example of one single key direct setting operation according to the present invention.

FIG. 8 is a circuit diagram showing the procedure of timer-controlled auto transmission flow according to the present invention.

### DETAILED DESCRIPTION OF THE PREFERRED EMBODIMENT

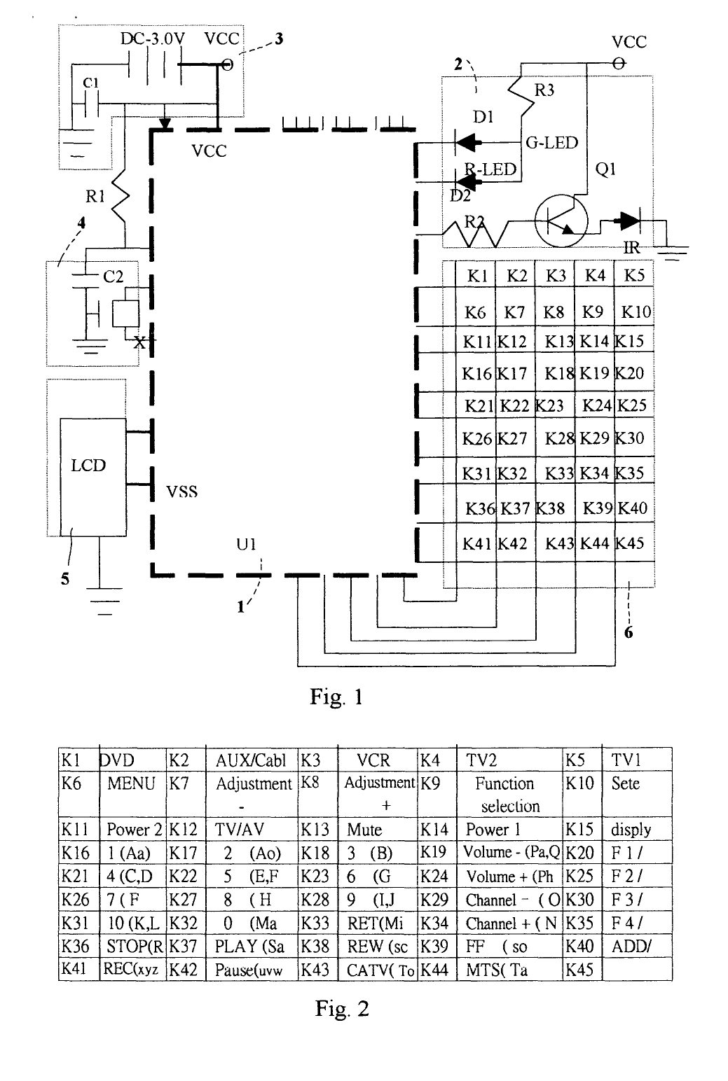

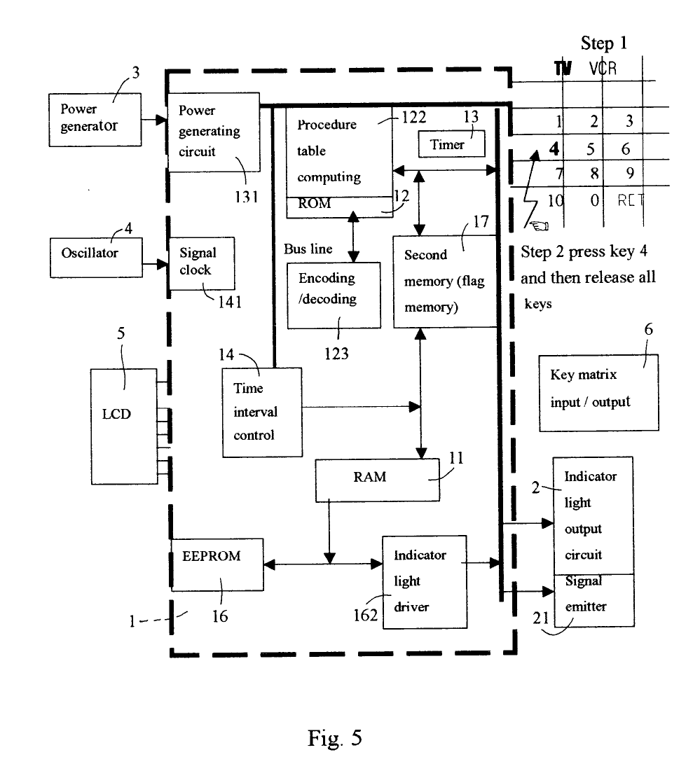

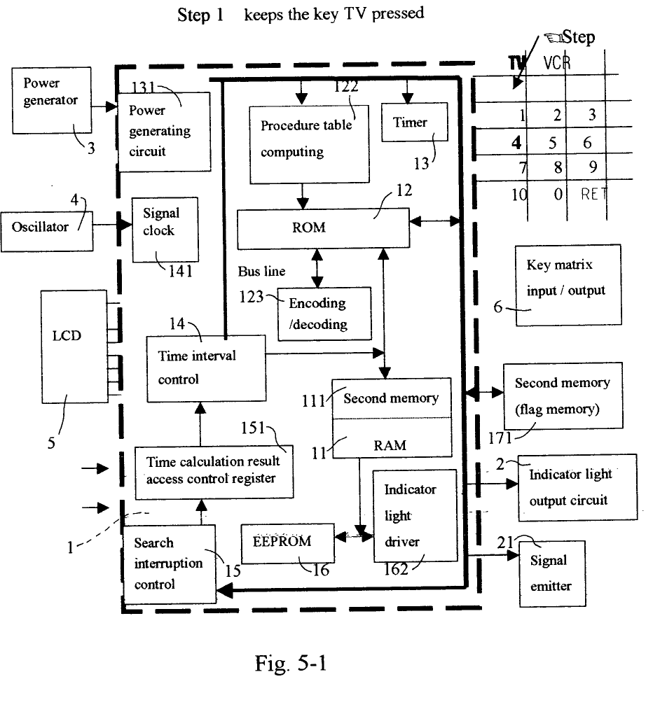

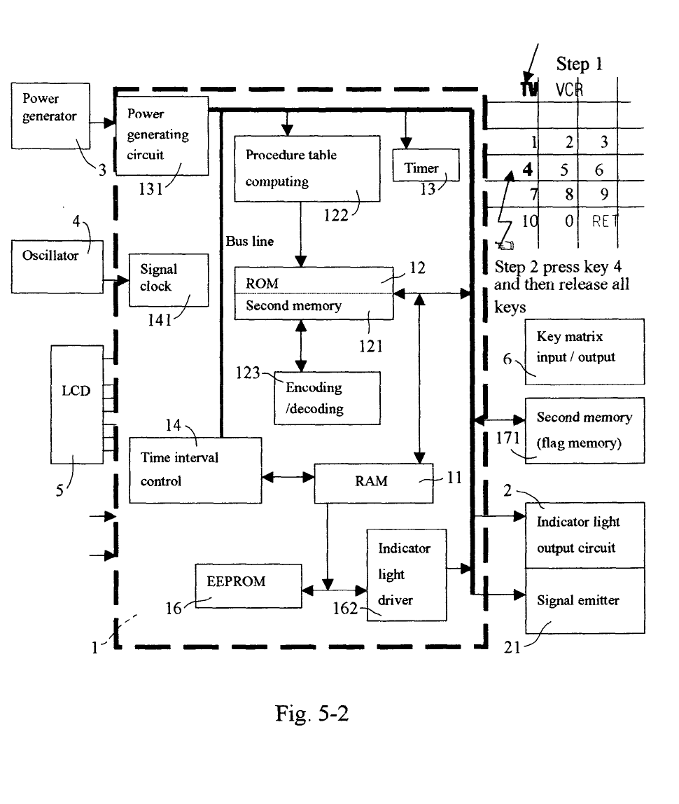

Referring to FIGS. 1˜3, the control circuit of a remote controller in accordance with the present invention is shown comprising a CPU 1. The CPU 1 comprises a main memory 11 adapted to record the search addresses and codes of all commercially available product models, at least one second memory 17 adapted to record the address flags of all product models indicated by the 26 English characters A˜Z. Alternatively, one second memory 17 can be divided into at least two memory zones 172 for recording the address flags of all product models indicated by the 26 English characters A˜Z to establish a product model code table corresponding to the numerical keys 0˜12 and keys CH+, CH−, VOL+, VOL−at the remote control. For example, the initial A of AIWA is placed at the address 1; the initial H of HITACHI is placed at the address 8 (see the function matrix table in FIG. 2). Because product category and address code are properly arranged, the user needs only to press the corresponding product category key and then the corresponding product model address numerical key to complete the setting (see the direct setting flow chart shown in FIG. 5). The CPU 1 further comprises a procedure table memory 12 adapted to record the functions of the keys of all product models recorded in the second memory and to provide the data of the function of every key for locking, an EEPROM (electrically erasable programmable read only memory) 16 adapted to record the functions of the keys of the originally set codes of every product model for keeping the set code functions of every product model in function after an interruption of power supply due to a temporary power low or power failure, a timer 13 adapted to count the search until an appears interruption for locking, a time interval control 14 adapted to control time interval at, for example, 1.5 seconds for locking, and a search interruption control 15 adapted to interrupt the searching action and to lock the frequency when the frequency matched. On the same circuit board outside the CPU 1, an external second memory 171 is provided and electrically coupled to the CPU 1 for recording the address flags of different product models indicated by the 26 English characters. The external second memory 171 may be divided into a plurality of memory zones 1711 for recording the address flags of different product models indicated by the 26 English characters. The main memory 11 of the CPU 1 may be divided into a plurality of memory zones 111 for recording the address flags of different product models indicated by the 26 English characters, or the procedure table memory (ROM) 12 may be divided into a plurality of memory zones 121 for recording the address flags of different product models indicated by the 26 English characters (see FIGS. 5-1 and 5-2).

The control circuit may be mounted with an indicator light driver 162 and an indicator light output circuit 2 and a signal emitter 21 for controlling on/off of the indicator light at the control panel and emitting frequency modulated search signal, and a power generator 3 to provide the CPU 1 with the necessary working voltage, and an oscillator 4 to provide the CPU1 with the function of counting time.

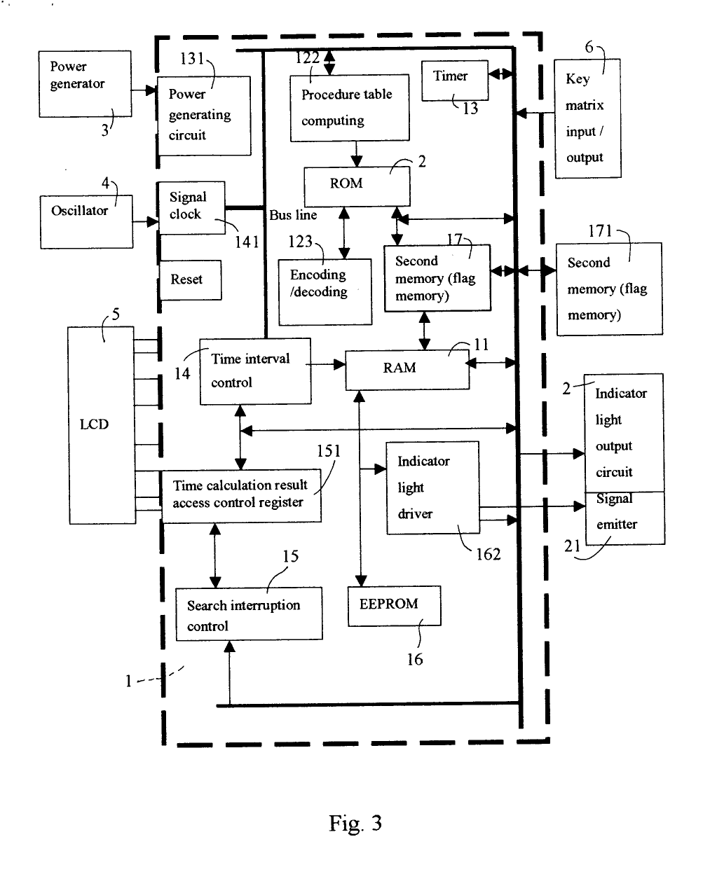

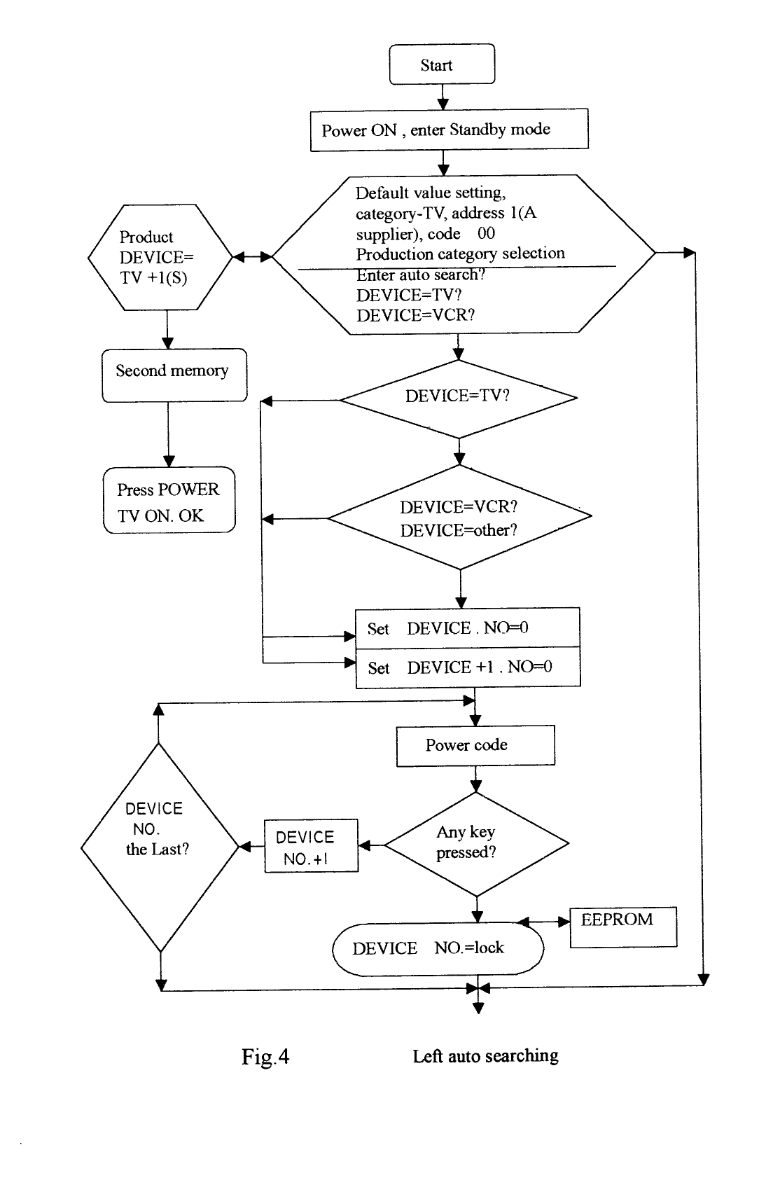

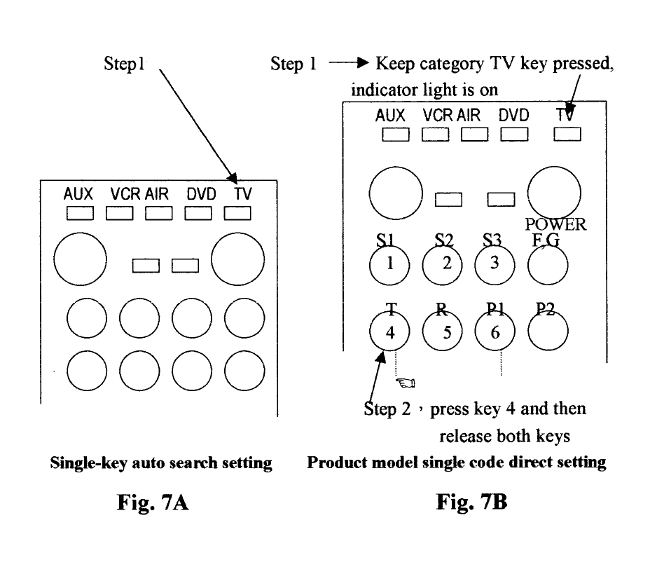

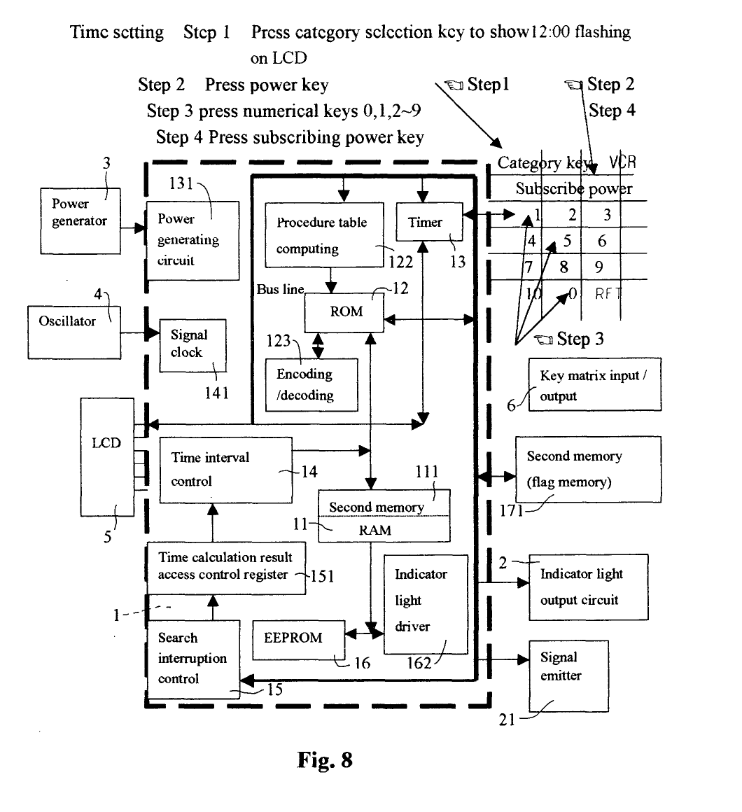

Referring to FIG. 3 again, when using the remote controller, the remote controller is aimed at the electric appliance (TV, video cassette tape recorder/player, CD player, stereo system, air conditioner, satellite TV-tuner, etc.). The first operation method (as shown in FIGS. 7A and 7B) is to press “product category key”, driving the CPU 1 to receive power supply from the power generator 3 and the oscillator 4 and to start automatic quick search action. During searching, product model code data and address data are respectively fetched from the main memory 11 and the second memory (flag supplementary data memory) 17 and then converted into an emission signal for emitting to the electric appliance through the signal emitter 21. Upon power On or Off reaction of the electric appliance, it means the frequency matched, and the search is interrupted. If not, the adding function of the timer 13 enables the CPU 1 to fetch next data from the main memory 11 and the second memory 17, and then to transmit a next transmission signal to the electric appliance for searching. During searching, the time interval control 14 controls the time interval between searches to be at, for example, 1.5 seconds. When the searched frequency matched, press the search interruption control 15 to lock the frequency. After locking, the CPU 1 fetches the corresponding key matrix input/output 6 from the procedure table memory 12, completing the setting (see the reference function table of the key matrix shown in FIG. 2.

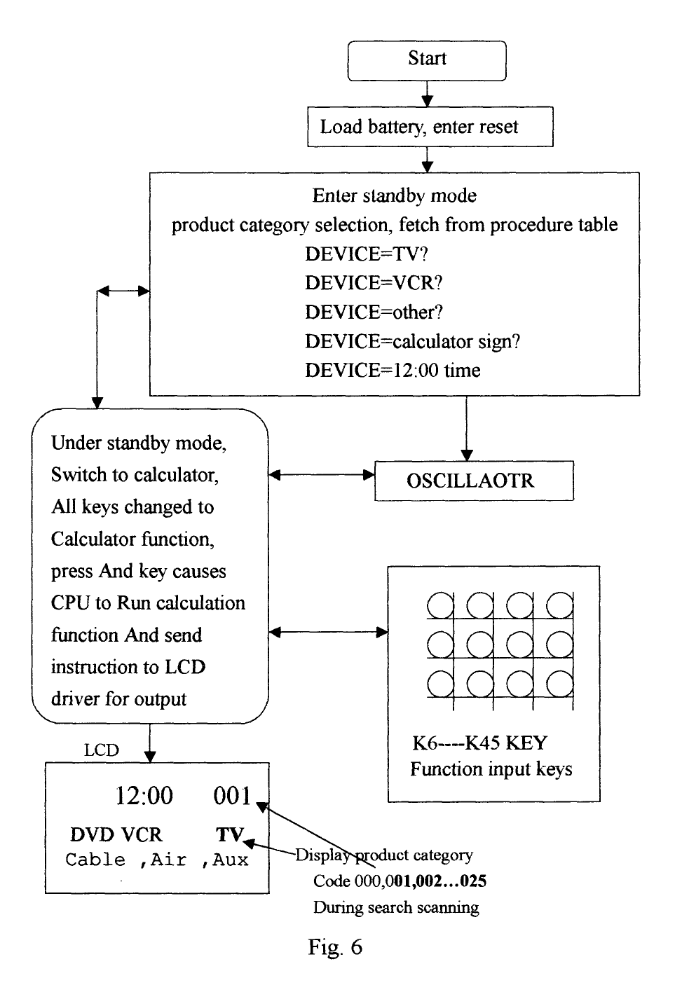

Referring to FIG. 3, the control circuit of the remote controller may be mounted with a LCD 5. The second operation method is to press “product category key”, and then to aim the remote controller at the electric appliance (TV, video cassette tape recorder/player, CD player, stereo system, air conditioner, satellite TV-tuner, etc.), and then to press “auto search key”, thereby entering auto quick search. During operation, the user can know the current mode. During auto search scanning, the LCD 5 displays the current product category (for example, TV and its numerical code; product category numerical codes are respectively indicated by 000, 001, . . . 010, and so on). When a power on/off reaction produced, it means the frequency matched, and the locking is done when pressing any key of the remote controller. At the same time, the produce category numerical code is shown on the LCD 5. When a calculator sign appeared on the LCD 5 during product category selection, the keys of the remote controller are defined to run the function of a calculator (see FIG. 6).

The operation principle of the present invention is outlined hereinafter.

At first, in addition to the main memory 11 at the CPU 1, at least one second memory 17 is provided to record product codes by the 26 English characters from A˜Z, and the numerical keys 0 . . . 9˜11˜12 and CH+, CH−, VOL+, VOL keys are used to match. A, B, C . . . YZ are put into numerical keys (see key function matrix table in FIG. 2) (the electric appliance suppliers having the initial A are put in the address 1; for example, HITACHI having the initial H is put in the address 8). According to this classification, about 1˜24 addresses are enough. The operation is quite simple (see FIGS. 7A and 7B). Keep the category key (for example, TV or VCR) pressed, and then press the numerical key 8 representing the initial H, and then release the keys at the same time to finish the setting. Thus, the remote controller is defined to substitute for the remote controller of the original product model. According to this method, there are twenty and more addresses for direct setting (see FIG. 5). If the direct setting is not operative, please use automatic quick search method as shown in FIGS. 5-1 and 7A, i.e., keeps TV key pressed for 1.5 seconds in which the indicator light is on and another 1.5 seconds in which the indicator light is off, and then release the key to enter auto searching state. The whole scanning cycle is done within a short period of time. It is faster than searching the code and then inputting the code that is composed of three numerals.

The product single code direct setting method of the invention is as follows:

At first, find the product address from the key function matrix table (see FIG. 2), (for example, the initial A of AIWA is placed at the address 1 and the initial H of HITACHI is placed at the address 8). By means of this classification method, twenty and more addresses are sufficient (arranged subject to the order of internal districts and product makers' scale). The operation procedure is quite simple. At first keeps the corresponding key of the key matrix input/output 6 (for example TV) pressed and then press the numerical address key 8, and then release the keys to complete the setting. (see FIGS, 5-2 and 7B).

With respect to timer-controlled auto emission, it is explained as follows:

After installation of battery in the remote controller (the default value of time of the remote controller is 12:00), press the category selection key and then release the hand from the category selection key when flashing of 12:00 appeared on the display screen of the LCD (5), and then press the power key of the key matrix input/output 6 and the numerical keys from 0˜9 to finish the setting.

If you wish to turn on the electric appliance at 3:00 PM, press the category selection key and then release the hand from the category selection key when flashing of 12:00 appeared on the display screen of the LCD (5), and then press the power key of the key matrix input/output 6 and the numerical keys from 0˜9 to show 15:00 on the LCD (5) without flashing, and then press the press the power key to complete the setting. If the remote controller A1 set to control the TV, the remote controller must be aimed at the TV within the angle of ±35° and the distance of 7.5 meters. When the set time comes, the remote controller automatically emits a power frequency signal to turn on the TV.

A prototype of remote controller has been constructed with the features of FIGS. 1˜8. The remote controller functions smoothly to provide all of the features discussed earlier.

Although particular embodiments of the invention have been described in detail for purposes of illustration, various modifications and enhancements may be made without departing from the spirit and scope of the invention. For example, the fans used can be cooling fans for use in hot weather, or fans with electric heater means for use in cold weather Accordingly, the invention is not to be limited except as by the appended claims.

1. A remote controller comprising
a CPU, said CPU comprising a main memory (random access memory) adapted to record the search addresses and codes of a plurality of product models, and at least one second memory adapted to record the address flags of said product models indicated by the 26 English characters;
a procedure table memory (read only memory) adapted to record the functions of keys of said product models and to provide the data of the function of every key for locking;
a timer adapted to count the search until an interruption appears for locking and to transmit power signal from pre-set counting start time to pre-set counting end time;
a time interval control adapted to control time interval for locking during searching;
a search interruption control adapted to interrupt the searching action and to lock the frequency when the frequency matched, and
a signal emitter adapted to emit a frequency modulated search signal.

2. The remote controller as claimed in claim 1, wherein said at least one second memory is respectively installed in said CPU, and respectively divided into a plurality of memory zones.

3. The remote controller as claimed in claim 1, further comprising an indicator light driver adapted to control on/off of an indicator light at the control panel of the remote controller, and a power generator adapted to provide the necessary working voltage to said CPU.

4. The remote controller as claimed in claim 1, further comprising an oscillator, which provides said CPU with the function of counting time.

5. The remote controller as claimed in claim 1, further comprising an electrically erasable programmable read only memory adapted to record the functions of the keys of the originally set codes of every product model for keeping the set code functions of every product model in function after an interruption of power supply due to a temporary power low or power failure.

6. The remote controller as claimed in claim 1, further comprising switch means for time display and time setting and product module function selection switching control.

7. The remote controller as claimed in claim 1, further comprising a liquid crystal display adapted to display numerical values and the remote controller's operation state

8. The remote controller as claimed in claim 1, wherein said main memory of said CPU has a part divided into a plurality of memory zones that form said at least one second memory.

9. The remote controller as claimed in claim 1, wherein said procedure table memory (read only memory) has a part divided into a plurality of memory zones that form aid at least one second memory.

10. A remote controller comprising
a CPU, said CPU comprising a main memory (random access memory) adapted to record the search addresses and codes of a plurality of product models;
at least one second memory adapted to record the address flags of said product models indicated by the 26 English characters;
a procedure table memory (read only memory) adapted to record the functions of keys of said product models and to provide the data of the function of every key for locking;
a timer adapted to count the search until an interruption appears for locking and to transmit power signal from pre-set counting start time to pre-set counting end time;
a time interval control adapted to control time interval for locking during searching,
a search interruption control adapted to interrupt the searching action and to lock the frequency when the frequency matched, and
a signal emitter adapted to emit a frequency modulated search signal.

11. The remote controller as claimed in claim 10, further comprising an indicator light driver adapted to control on/off of an indicator light at the control panel of the remote controller; and a power generator adapted to provide the necessary working voltage to said CPU.

12. The remote controller as claimed in claim 10, further comprising an oscillator, which provides said CPU with the function of counting time.

13. The remote controller as claimed in claim 10, further comprising an electrically erasable programmable read only memory adapted to record the functions of the keys of the originally set codes of every product model for keeping the set code functions of every product model in function after an interruption of power supply due to a temporary power low or power failure.

14. The remote controller as claimed in claim 10, further comprising a liquid crystal display adapted to display numerical values and the remote controller's operation state.

15. The remote controller as claimed in claim 10, further comprising an external second memory mounted on a circuit board carrying said CPU and electrically coupled to said CPU, said external second memory being divided into a plurality of memory zones.

16. The remote controller as claimed in claim 10, wherein said main memory of said CPU has a part divided into a plurality of memory zones that form said at least one second memory.
